(19) United States
(12) Patent Application Publication
(10) Pub. No.: US 2008/0155182 A1
(43) Pub. Date: Jun. 26, 2008

(54) NON-VOLATILE SEMICONDUCTOR MEMORY SYSTEM AND DATA WRITE METHOD THEREOF

(75) Inventor: Yasuo KUDO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/923,041

(22) Filed: Oct. 24, 2007

(30) Foreign Application Priority Data
Oct. 30, 2006 (JP) 2006-294184

(51) Int. Cl. G06F 12/00

(52) U.S. Cl. 711/103

(57) ABSTRACT

A non-volatile semiconductor memory system includes: a non-volatile semiconductor memory device having a data storage area defined by a plurality of blocks, each block serving as an erase unit; and a memory controller configured to control read/write of the non-volatile semiconductor memory device, wherein the non-volatile semiconductor memory device is write-controlled in such a manner that a data unit is written into a data area from the head address of a block with a capacity of integer times the block capacity.

### CROSS-REFERENCE TO RELATED APPLICATION

This application is based on and claims the benefit of priority from the prior Japanese Patent Application No. 2006-294184, filed on Oct. 30, 2006, the entire contents of which are incorporated herein by reference.

### BACKGROUND OF THE INVENTION

1. Field of the Invention

This invention relates to a non-volatile semiconductor memory system having a non-volatile semiconductor memory device and a controller for controlling read/write thereof.

2. Description of the Related Art

A NAND-type flash memory is known as one of electrically rewritable and non-volatile semiconductor memories (EEPROMs). The NAND-type flash memory has features as follows: unit cell area thereof is smaller than that of NOR-type one; and it is easy to increase the capacity. Further, although the read/write speed for each cell is slower than that of NOR-type one, increasing a cell range (i.e., physical page length), in which data are simultaneously read/written between the cell array and a page buffer, it becomes possible to perform read/write at a substantially high rate.

To make the above-described features effective, NAND-type flash memories are used as various recoding media such as a file memory, a memory card and the like.

In the NAND-type flash memory, a set of NAND cell units arranged in the word line direction is defined as a block, which serves as a data erase unit. To rewrite data in a block, it is in need of writing data after erasing the block in a lump.

However, there will be often happened such a situation that the head address of a to-be-rewritten data file area is located midway in a block while another data file, which is not to be rewritten, is written in the same block. To collectively erase the above-described block, it is necessary to do a copy-write operation for caching the “another data file”, which is not to be rewritten, to a spare block (for example, refer to JP-P2006-040264A).

### SUMMARY OF THE INVENTION

According to an aspect of the present invention, there is provided a non-volatile semiconductor memory system including:

a non-volatile semiconductor memory device having a data storage area defined by a plurality of blocks, each block serving as an erase unit; and

a memory controller configured to control read/write of the non-volatile semiconductor memory device, wherein

the non-volatile semiconductor memory device is write-controlled in such a manner that a data unit is written into a data area from the head address of a block with a capacity of integer times the block capacity.

According to another aspect of the present invention, there is provided a data write method of a non-volatile semiconductor memory system, the data storage area of which is formed of multiple blocks each serving as an erase unit, including:

writing real data of a data unit in a certain area of the non-volatile semiconductor memory in such a manner that the certain area is so embedded from the head address of a block with the real data as to leave an unwritten area in another block; and

writing dummy data in the unwritten area, thereby resulting in that the data unit containing the real data and the dummy data occupies a data area with a capacity of integer times the block capacity.

### BRIEF DESCRIPTION OF THE DRAWINGS

FIG. 1 shows a configuration of a non-volatile semiconductor memory system in accordance with an embodiment of the present invention.

FIG. 2 shows a functional block configuration of the memory system.

FIG. 3 shows a memory cell array configuration of the memory system.

FIG. 4 shows a data write situation of the memory system.

FIG. 5 shows a write sequence of the memory system.

FIG. 6 shows a command sequence for getting write-start address, which is performed as a previous processing of data write.

FIG. 7 shows a command sequence for noticing the write end address.

FIG. 8 shows a specific command sequence.

FIG. 9 shows a data write state in accordance with another embodiment.

### DETAILED DESCRIPTION OF THE EMBODIMENTS

Illustrative embodiments of this invention will be explained with reference to the accompanying drawings below.

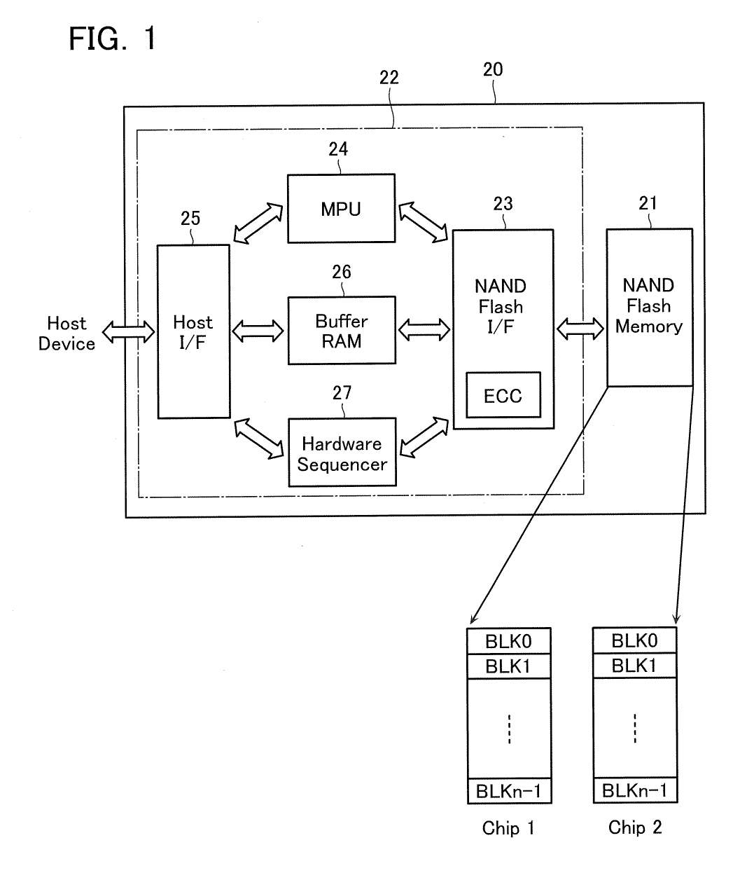

FIG. 1 shows a configuration of a non-volatile semiconductor memory system 20 in accordance with an embodiment. This memory system 20 has a NAND-type flash memory chip 21 and a memory controller for controlling read/write thereof, which constitute a memory module (e.g., a memory card).

The flash memory chip 21 may be often formed of multiple chips, for example, two chips Chip 1 and Chip 2, as shown in FIG. 1. Even if multiple chips are contained, these are controlled by one memory controller 22. The whole installed memory chips will be controlled as one logic memory based on logic address.

In other words, a host device accesses the flash memory with not a physical block address (PBA) base but a logic block address (LBA) base. Therefore, this flash memory system 20 will be referred to as an LBA-NAND memory hereinafter.

The memory controller 22 is a one-chip controller including: a NAND flash interface 23 serving for data transferring between the memory chip 21 and itself; a host interface 25 serving for data transferring between itself and a host device; a buffer RAM for temporally storing read/write data and so on; an MPU 24 for controlling the data transferring; and a hardware sequencer 27 used, for example, for sequence-controlling read/write of firmware (FW) in the NAND-type flash memory 21.

Firmware (FW) required of the memory controller 22 is automatically read out from the flash memory chip 21 to be transferred to the buffer RAM (data register) in an initial setup mode, which is automatically executed just after power on. This data read control will be performed with the hardware sequencer 27 in the memory controller 22.

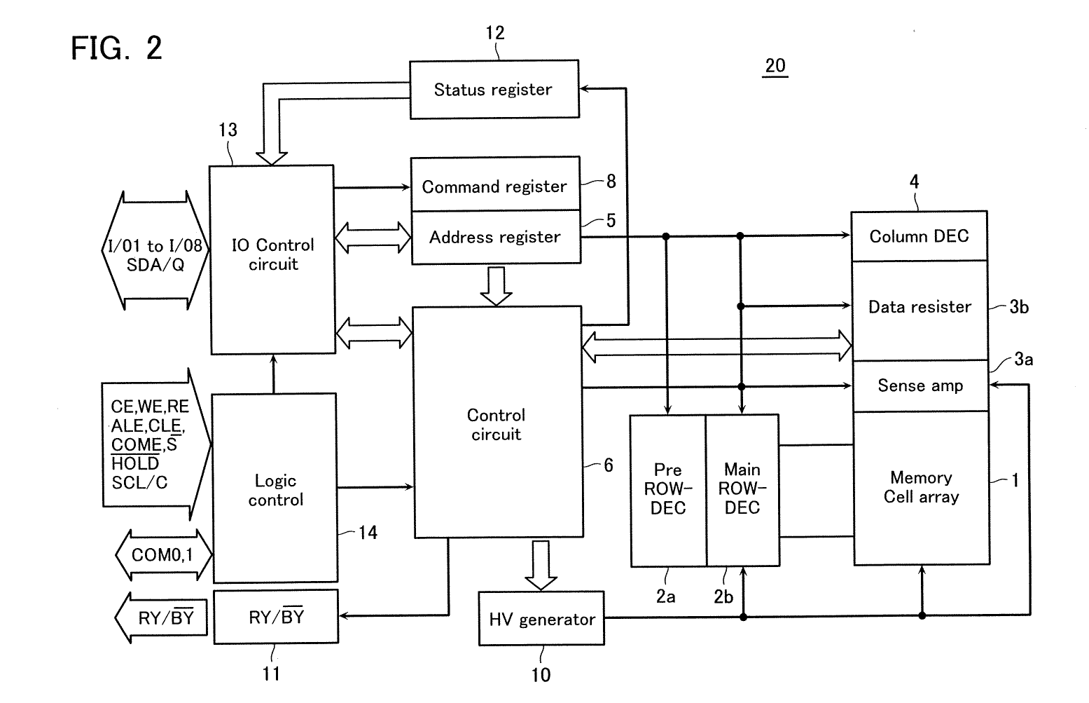

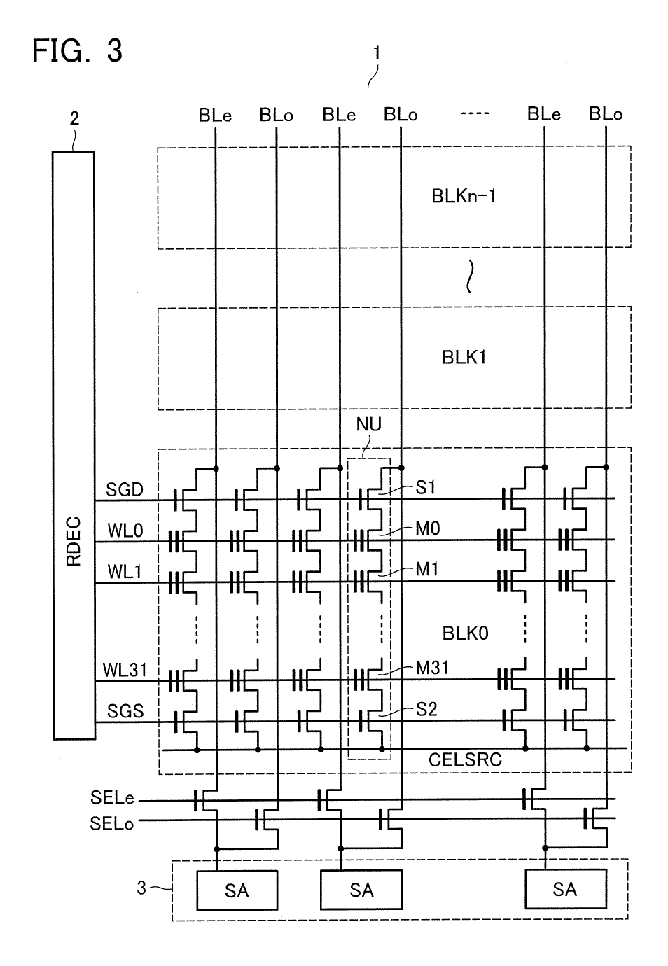

Note here it is not essential for the LBA-NAND memory system in accordance with this embodiment that memory chip 21 and memory controller 22 are formed as independent chips of each other. FIG. 2 shows a functional block of the LBA-NAND memory 20, in which memory chip 21 and memory controller 22 shown in FIG. 1 are integrally formed in perfect harmony; and FIG. 3 shows the cell array arrangement of the memory core portion.

Memory cell array 1 is, as shown in FIG. 3, formed of NAND cell units (NAND strings) NU arranged therein, each of which is formed of a plurality of electrically rewritable and non-volatile memory cells (i.e., 32 memory cells in this case) M0-M31 connected in series.

One end of the NAND cell unit NU is coupled to a bit line BLe or BLo via a select gate transistor 51; and the other end to a cell source line CELSRC via another select gate transistor S2. Control gates of the memory cells M0-M31 are coupled to word lines WL0-WL31, respectively; and gates of the select gate transistors S1 and S2 to select gate lines SGD and SGS, respectively.

A set of NAND cell units arranged in the direction of the word lines constitutes a block, which serves as the minimum unit of data erase. As shown in FIG. 3, multiple blocks are arranged in the direction of the bit line.

Disposed at one end of the bit lines BLe and BLo is a sense amplifier, which serves for reading and writing cell data while disposed at one end of the word lines is a row decoder 2, which serves for selectively driving word lines and select gate lines. In FIG. 3, it is shown such an example that adjacent even numbered bit lines BLe and odd numbered bit lines BLo are selectively coupled to sense amplifiers S/A in the sense amplifier circuit 3 via a bit line select circuit.

Command, address and data are input via I/O control circuit 13; and chip enable signal /CE, write enable signal /WE, read enable signal /RE and other external control signals are input to a logic control circuit 14 and serve as timing control signals. The input command will be decoded at command register 8.

Control circuit 6 is configured to control data transferring and perform sequence control of write/erase/read. Status register 11 is prepared to output a Ready/Busy state of the LBA-NAND memory 20 to a Ready/Busy terminal. In addition to the status register 11, another status register 12 is prepared to teach some states of memory 20 (Pass/Fail, Ready/Busy and the like) to the host device via a certain I/O port.

The input address is transferred to the row decoder 2 (including pre-row decoder 2a and main row decoder 2b) and column decoder 4 via address register 5. The input write data is loaded in the sense amplifier circuit 3 (including sense amplifier 3a and data register 3b) via I/O control circuit 13 while read data is output outside via the control circuit 6 and I/O control circuit 13.

To generate various high voltages necessary for operation modes, a high voltage generating circuit 10 is prepared. This high voltage generating circuit 10 generates high voltages in response to instructions supplied from the controller 6.

In the above-described LBA-NAND flash memory system in accordance with this embodiment, a data unit to be written is always controlled to occupy a data area with an integer times block capacity (i.e., block size D), the head address of which is one of a block. This write area control will be explained below.

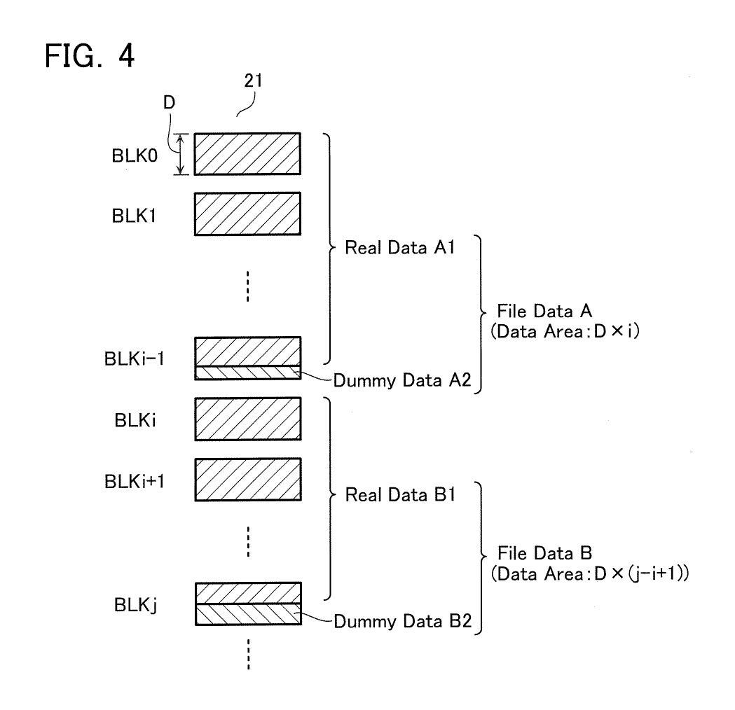

FIG. 4 shows a data write situation of the flash memory in accordance with this embodiment. File data A is, for example, formed of real data A1 and dummy data A2. The real data A1 is written from the head address of block BLK0 to a halfway location of block BLKi−1 in the flash memory; and the dummy data A2 is embedded in the remaining area (i.e., fractional page area) of the block BLKi−1. That is, supposing that one block capacity is defined by block size D shown in FIG. 4, the file data A is written to occupy a data area of D×i.

As a result, as sequentially written file data B, real data B1 thereof may be written from the head address of the block BLKi to a halfway location in block BLKj. The remaining fractional pages of the block BLKj will be embedded with dummy data B2 like the case of file data A.

It is decided in accordance with types of the file data how the above-described dummy data should be used. For example, the following two cases, CASE1 and CASE2, will be explained in detail.

CASE1: this is such a case that the file data is one selected from, for example, music data, movie data and the like, and the host device (or system) is able to optionally decide the data size. In case the final address of recording data has not reached the final address of a block, the host system transfers and records dummy data to completely fill the block. For example, history information data of the recording data may be used as the dummy data. Alternatively, it is permissible to leave the remaining area empty as it is, and record only information such as an “END OF FILE” mark at the final address of the block, so that the remaining area is dealt with an effective area (i.e., the unwritten area is set as an write-forbidden area). Further, in case of movie data recoding, data of a few or several seconds may be written as the dummy data that is written after operating the stop button.

CASE2: this is such a case that it is difficult to change the data size, for example, such a case that the file data is to be written in a file on a personal computer (PC). In this case, the host system calculates the remaining address space from the final address of the file data to that of a block, and writes dummy data in the remaining address apace. In this case, a kind of text data linked to the written data, temporary random data and the like may be used as the dummy data. This dummy data will be registered as “effective data” on the PC. Alternatively, it is effective to register the remaining address space as “effective data area” on the PC without writing any actual file data in the remaining address space. In detail, it is permissible to regard the remaining address space as an area which is used by the host system or a bad cluster.

As described above, every data unit, which includes read data and dummy data if necessary attached to the real data, is always written from the head address of a block to occupy a data area with integer times block capacity. According to this write control scheme, there is not happened such a situation that different files are written in a block. Therefore, to erase unnecessary file data, collective block erase may be performed without executing a copy-write operation for caching other file data, which are not to be erased. As a result, the high-speed performance of the host device will not be spoiled.

Note here that the real data in one data unit is to-be-written data in accordance with a write sequence with sector count value and sector address (initial value) input as described later.

It is effective that the areas of dummy data A2 and B2 are not embedded with these dummy data, but set to be write-forbidden areas as being left empty. The write-forbidden areas may be set in such a way as to, for example, prepare a protect register for storing write-forbidden addresses (at least the head addresses thereof) corresponding to the write-forbidden areas. Further, the dummy data writing or write-forbidden area setting may be performed in response to instructions of the host device using the memory system. Alternatively, it is also effective that memory controller 22 in the flash memory system 20 automatically executes the dummy data writing or the write-forbidden area setting after the real data writing.

In the LBA-NAND memory in accordance with this embodiment, one sector (for example, 512Byte) serves as a data transfer unit for data reading/writing, and SSFDC (Solid State Floppy Disk Card) format is used as data transfer format. By use of a sector count scheme, a command being issued once, it is possible to continue data read/write for multiple sectors.

For example, to write N sector data, the host sequentially inputs a write command, sector count numbers (for example, first sector count (1Byte) and second sector count (1Byte)), logical sector address (initial value), write data of N sectors, and a write-start command. In accordance with this command sequence, the memory controller executes continuously N-sector data write.

In this write scheme, the host does not control the physical address of the flash memory. Therefore, to write a file data in the flash memory from the head address of a block, it is required of the host to get the head address of a block in a spare area in the flash memory.

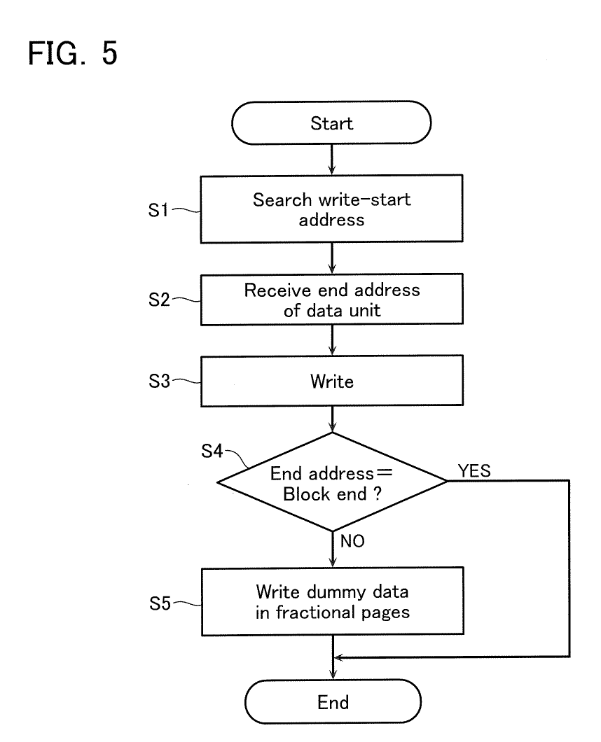

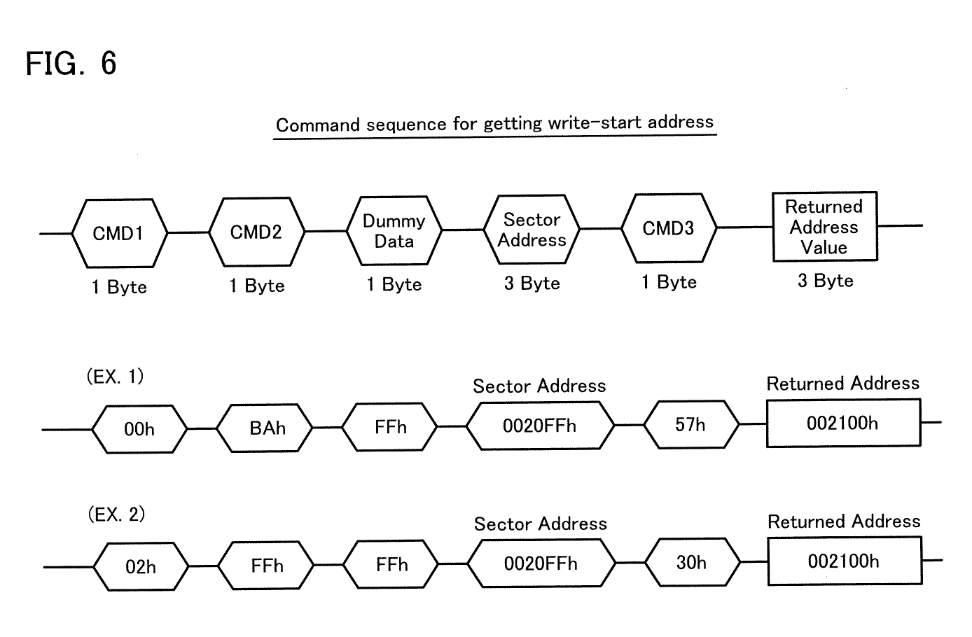

FIG. 5 shows a summarized write sequence of the memory controller 22 in accordance with this embodiment. Prior to the normal write sequence, in response to instructions of the host, it is executed such a previous process as to search a write-start address (step S1). For example, as the command sequence of the host for getting the write-start address, as shown in FIG. 6, it will be used such the basic command structure like in the normal read mode as follows: CMD(1Byte)/first sector count(1Byte)/second sector count(1Byte)/sector address (3Byte)/CMD(1Byte).

Explaining in detail, write command CMD1 is input, following it specific command CMD2 (1Byte) and dummy data(1Byte) are input in place of the first and second sector counts to be normally input, and then write sector address (3Byte) and execute command CMD3(1Byte) are successively input.

In response to the specific command CMD2 and execute command CMD3, controller 22 in the LBA-NAND memory searches a physical write-start address corresponding to the input logical sector address (initial value). To confirm it, the host gets the write-start address corresponding to the input sector address as a “returned address value”.

In FIG. 6, it is shown two examples EX.1 and EX.2 of the command sequence for getting the above-described write-start address.

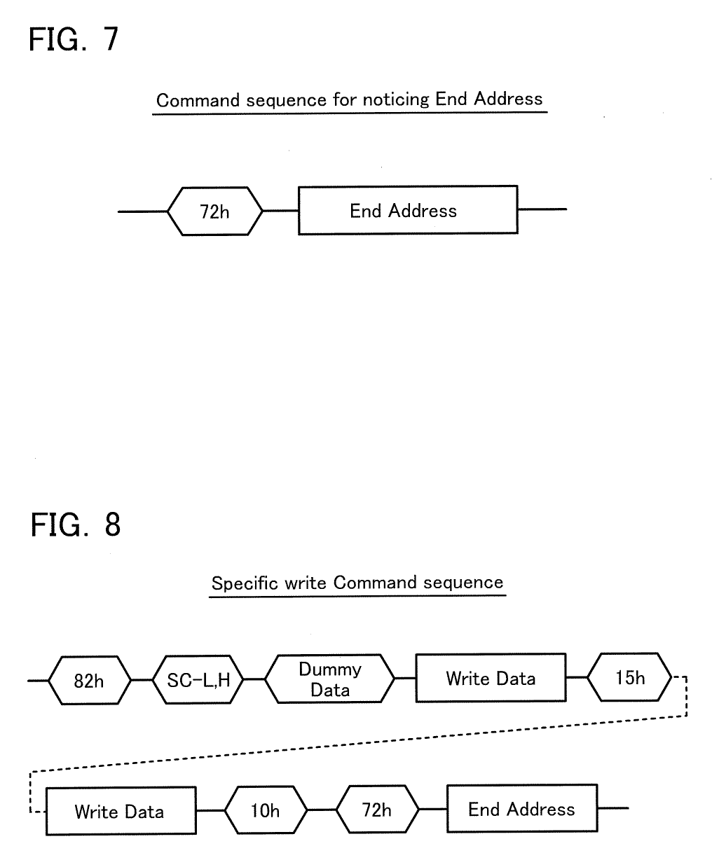

Following the above-described previous process for getting the write-start address, the host issues, as shown in FIG. 7, an additional command for noticing the end address of the write data unit. The memory controller 22 receives it (step S2), and then executes data write (step S3).

At this time, the specific write sequence of the host will be expressed as, for example, shown in FIG. 8. Since the flash memory has gotten the write-start address via the previous process command sequence, there is no need of issuing write command with sector address. Therefore, following the specific write command <82h>, first sector count (L-level side one) SC-L and second sector count (H-level side one) SC-H are input; dummy data is input in place of the sector address; a necessary amount of write data are input; and write-start command <10h> is input. As a result, the LBA-NAND memory performs data write of N sectors from the head address of a block matched to the instructed logical address.

Note here, FIG. 7 shows such a case that the end address is noticed prior to write data transferring while FIG. 8 shows such a case that the write data transferring is followed by the end address noticing.

After writing, it is detected whether the noticed end address is identical with a block end address or not (step S4). If YES, this write sequence ends. If NO, dummy data is written into the remaining area (fractional pages) in the final block of the data write area (step S5).

Explaining in detail, when receiving the judgment “NO” at step S4, the host calculates data amount corresponding to the fractional pages; inputs sector count, sector address (the end address +1) and dummy data defined by the calculated data amount; and executes dummy data write as well as the normal sector write. That is, the memory controller 22 executes dummy data write in the fractional pages in the block under the condition that the physical address corresponding to the noticed end address +1 serves as the write-start address (step S5).

As a result, in the LBA-NAND memory, the successive empty area is always defined as starting from the head address of a block.

Note here that the fractional page area may be set to be a write-forbidden area as being empty as it is without executing the specific dummy data write as described above. Additionally, it is possible to use such a scheme that the memory controller in the flash memory system 20 automatically executes the dummy data writing or the write-forbidden area setting without instructions of the host device.

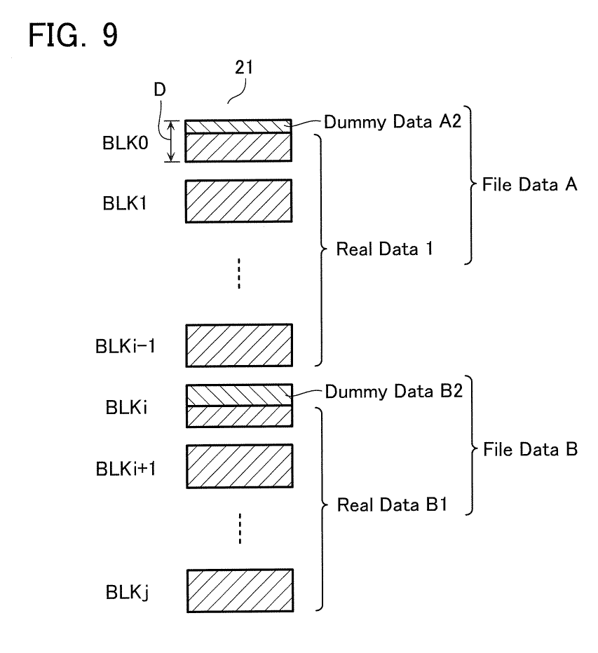

In the above-described embodiment, as shown in FIG. 4, the real data A1 and B1 are written from the head addresses of the corresponding blocks, and dummy data A2 and B2 are written in the fractional page areas in the other corresponding blocks. By contrast, it should be permitted, as shown in FIG. 9, to write the dummy data A2 and B2 from the head address areas of the corresponding blocks, and successively write the real data A1 and B1, respectively, so that the file data A and B each occupies a region with integer times block size D.

To achieve the scheme shown in FIG. 9, for example, it is required of the host to previously know the block size D; and previously calculate a block occupying state with to-be-written real data and the dummy data amount to be embedded in the fractional page area. On this condition, as similar to that in the above-described embodiment, data write is performed from the head address of a block in accordance with basically the same write sequence as shown in FIG. 8. In this case, as the write data shown in FIG. 8, the dummy data and the real data will be transferred in this order. It is the same as in the above-described embodiment that it is in need of previously processing to get the head address of a block. While, it becomes unnecessary to notice the end address as explained with reference to FIGS. 7 and 8.

This invention is not limited to the above-described embodiment. It will be understood by those skilled in the art that various changes in form and detail may be made without departing from the spirit, scope, and teaching of the invention.

What is claimed is:

1. A non-volatile semiconductor memory system comprising:
a non-volatile semiconductor memory device having a data storage area defined by a plurality of blocks, each block serving as an erase unit; and
a memory controller configured to control read/write of the non-volatile semiconductor memory device, wherein
the non-volatile semiconductor memory device is write-controlled in such a manner that a data unit is written into a data area from the head address of a block with a capacity of integer times the block capacity.

2. The non-volatile semiconductor memory system according to claim 1, wherein
real data of the data unit is so written in the data area as to leave an unwritten area in a block, and dummy data is embedded in the unwritten area.

3. The non-volatile semiconductor memory system according to claim 1, wherein
real data of the data unit is so written in the data area as to leave an unwritten area in a block, and the unwritten area is set to be in a write-forbidden state.

4. The non-volatile semiconductor memory system according to claim 2, wherein
the real data is written ahead of the dummy data, and the dummy data is written in accordance with instructions of a host device using the memory system.

5. The non-volatile semiconductor memory system according to claim 2, wherein
the real data is written ahead of the dummy data, and the dummy data is automatically written under the control of the memory controller.

6. The non-volatile semiconductor memory system according to claim 3, wherein
the write-forbidden state is set in accordance with instructions of a host device using the memory system.

7. The non-volatile semiconductor memory system according to claim 3, wherein
the write-forbidden state is automatically set under the control of the memory controller.

8. The non-volatile semiconductor memory system according to claim 2, wherein
the unwritten area is previously detected prior to inputting the real data, and the dummy data is written ahead of the real data.

9. The non-volatile semiconductor memory system according to claim 3, wherein
the unwritten area is previously detected and set to be in the write-forbidden state prior to inputting the real data.

10. The non-volatile semiconductor memory system according to claim 1, wherein
a read/write access area of the non-volatile semiconductor memory device is set in such a manner that data transfer unit being defined by a sector, a host inputs sector count value and sector address initial value together with a command.

11. The non-volatile semiconductor memory system according to claim 1, wherein the memory system is a memory card.

12. A data write method of a non-volatile semiconductor memory system, the data storage area of which is formed of multiple blocks each serving as an erase unit, comprising:
writing real data of a data unit in a certain area of the non-volatile semiconductor memory in such a manner that the certain area is so embedded from the head address of a block with the real data as to leave an unwritten area in another block; and
writing dummy data in the unwritten area, thereby resulting in that the data unit containing the real data and the dummy data occupies a data area with a capacity of integer times the block capacity.

13. The data write method according to claim 12, wherein
the real data is written ahead of the dummy data, and the dummy data is written in accordance with instructions of a host device using the memory system.

14. The data write method according to claim 12, wherein
the real data is written ahead of the dummy data, and the dummy data is automatically written under the control of a memory controller contained in the memory system.

15. The data write method according to claim 12, wherein
the unwritten area is previously detected prior to inputting the real data, and the dummy data is written ahead of the real data.

16. The data write method according to claim 12, wherein
a read/write access area of the non-volatile semiconductor memory is set in such a manner that data transfer unit being defined by a sector, a host inputs sector count value and sector address initial value together with a command.
